(19) United States
(12) Patent Application Publication
(10) Pub. No.: US 2012/0311016 A1
(43) Pub. Date: Dec. 6, 2012

(54) SYSTEM AND METHOD FOR PROVIDING SELF-HEALING CAPABILITES IN A DISTRIBUTED KNOWLEGDE NETWORK/INTELLIGENT SENSOR NETWORK

(75) Inventors: Robert DeAnna, Frisco, TX (US); John Patoskie, Allen, TX (US); Robert W. Peterson, Plano, TX (US); Thomas T. Wheeler, Frisco, TX (US); Qin Ye, Plano, TX (US)

(73) Assignee: RECURSION SOFTWARE, INC., Frisco, TX (US)

(21) Appl. No.: 13/151,707

(22) Filed: Jun. 2, 2011

(51) Int. Cl. G06F 15/16

(52) U.S. Cl. 709/202

(57) ABSTRACT

To provide self-healing capabilities in a distributed knowledge network/intelligent sensor network, a node monitoring task agent can be deployed to a node to determine operating parameters of the node or of other task agents executing on the node. The operating parameters can be passed to a node monitoring data analysis engine which can analyze the data by referencing a rule-set. The analyzed data can be passed to a management application which can determine whether any self-healing actions need to be performed, such as moving the task agents to other healthier nodes of the DKN-ISN.

### CROSS REFERENCE TO RELATED APPLICATIONS

This application is related to co-pending applications of the present applicants and/or assignees including Attorney Docket Nos.: 20091113.1, 20080529.2 and 20091117.1 The entire contents of these applications are incorporated herein by reference.

### FIELD OF THE INVENTION

This disclosure relates to software platforms and architectures and in particular to platforms and architectures for use in a heterogeneous device environment.

### BACKGROUND OF THE INVENTION

There is an explosion of mobile and embedded devices throughout the consumer, commercial and government arenas. These devices have ever increasing processing power, data gathering power and data storage capacity. Additionally there is a growing need for advanced applications that are centered around the use case of a dynamic collection of people and devices, for some transient period of time, participated in a coordinate process, task, goal involving knowledge sharing. These types of application range from the DoD, DHS, and Commercial and Consumer worlds. The need for a software platform that enables a Distributed Knowledge Network is now very evident.

But there is currently no Distributed Knowledge Network platform to enable intelligent applications that span these heterogeneous networks and devices, underlying operating systems, software languages, and software protocols. This is not only true for simple client-server mobile environments, but also environments that involve peer-2-peer and peer-2-group communication.

There are no solutions that enable end-to-end Distributed Knowledge Networks and Intelligent Sensor Networks. There are platforms for client-server applications, and simple peer-2-peer networks, but there are no intelligent, unified pervasive platforms that allow for intelligent data gathering, synthesis, fusion and distribution over dynamic collections of heterogeneous devices.

Existing software platforms are either not pervasive enough or intelligent enough. By pervasive, it is meant that the platforms that do exist either are limited in the devices/operating systems they support, or the software languages they support, or the distributed protocols they support, or the messaging capabilities they support.

A next generation intelligent, mobile agent platform of the type described in the Applicant's co-pending patent applications Attorney Docket Nos. 20091113.1 and 20080529.2, referenced above, offers a solution to the current problems faced in DKN-ISN environments, one of which is processing large amounts of data across less-than-reliable mobile networks over an increasing number of nodes ranging from enterprise server to handheld and embedded devices and sensors.

As these distributed DKN-ISNs grow in node count, geographic dispersal, heterogeneity, and overall complexity, configuration, startup, monitoring, managing, shutdown, and retrieval of results becomes increasingly difficult. Some DKN-ISNs require a person's keystrokes on each system console to start and stop a DKN-ISN node. Localizing and automating configuration, management and healing of a distributed DKN-ISN controls costs by reducing the DKN/ISN failures/down-time, personnel to manage a DKN/ISN, configuration errors, and the time required to evaluate DKN/ISN data.

What is required is a system, method and/or architecture that meets these requirements.

### SUMMARY OF THE INVENTION

To provide self-healing capabilities in a distributed knowledge network/intelligent sensor network, a node monitoring task agent can be deployed to a node to determine operating parameters of the node or of other task agents executing on the node. The operating parameters can be passed to a node monitoring data analysis engine which can analyze the data by referencing a rule-set. The analyzed data can be passed to a management application which can determine whether any self-healing actions need to be performed, such as moving the task agents to other healthier nodes of the DKN-ISN.

In one aspect of the disclosure, there is provided a method for monitoring a node of a distributed knowledge network/intelligent sensor network. The method may comprise deploying a node monitoring task agent to a node of the distributed knowledge network/intelligent sensor network, executing the node monitoring task agent at the node, determining one or more parameters of the node using the node monitoring task agent, determining one or more self-healing tasks dependent on the one or more parameters, and performing the one or more self-healing tasks.

In one aspect of the disclosure, there is provided a distributed knowledge network/intelligent sensor network comprising a plurality of nodes. At least one node may comprise a node monitoring task agent configured to determine one or more parameters of the node and pass the one or more parameters to a node monitoring data analysis engine. The node monitoring data analysis engine may be configured to analyze the one or more parameters of the node by referencing a rule-set and pass the analyzed data to a management application. The management application may be configured to determine one or more management actions for the node from the analyzed data.

In one aspect of the disclosure, there is provided a computer-readable medium comprising computer-executable instructions for execution by at least one first processor, that, when executed, cause the at least one first processor to receive a node monitoring task agent into a node of a network, execute the node monitoring task agent in the node, determine one or more parameters of the node using the node monitoring task agent, and pass the one or more parameters to a node monitoring data analysis engine.

### BRIEF DESCRIPTION OF THE DRAWINGS

Reference will now be made, by way of example only, to specific embodiments and to the accompanying drawings in which:

FIG. 1 depicts a process for monitoring nodes of a DKN/ISN;

FIG. 2 depicts an embodiment of an agent-Based Linking of Distributed Systems Architecture;

FIG. 3 depicts a process for determining adapter agent behavior;

FIG. 4 depicts a process for authenticating a task agent on a node; and

FIG. 5 depicts a process for performing node monitoring and management.

### DETAILED DESCRIPTION OF THE INVENTION

As will be described herein, next generation DKN-ISNs will utilize a self-monitoring, self-healing agent-based approach to link and manage participating nodes providing pertinent, timely information to participants using Smartphones, PDA's, laptops, and personal workstations. This approach takes advantage of mobile agents to increases DKN/ISN reliability and stability, while reducing bandwidth usage, and increasing the ability to filter and analyze data at its source.

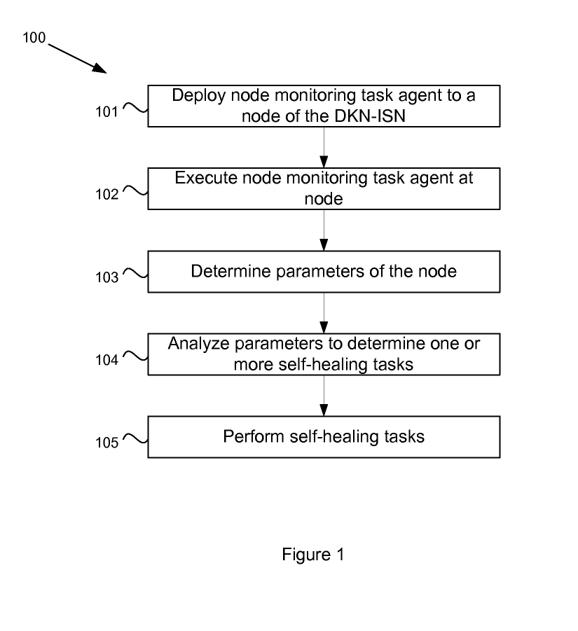

A method for monitoring nodes of a DKN/ISN is depicted in the flowchart 100 of FIG. 1. At step 101, a node monitoring task agent is deployed to a node of the DKN/ISN. At step 102, the node monitoring task agent executes at the node to determine parameters of the node and/or other task agents executing at the node (step 103). The parameters are analyzed to determine one or more self-healing tasks (step 104) which are then performed (step 105).

DKN-ISN Agent Process Description

Mobile DKN-ISN agents, deployed to edge devices, will process and combine raw data from large, distributed, heterogeneous, multi-dimensional data sets containing complex spatial and/or temporal dynamics to detect patterns and irregularities. Patterns and irregularities are detected using learning algorithms and data mining to examine correlations and perform classification, clustering, change and deviation detection, summarization, and dependency modeling. Mobile DKN-ISN agents will pre-process, filter, polish, and extract features from raw data on edge devices, ensuring that knowledge is transmitted rather than large amounts of raw data. Agents will select relevant subsets of data, remove noise and outliers, and decide on a strategy for parsing the data in the most efficient manner to a variety of devices across wireless networks.

DKN-ISN Management Agent Process Description

A DKN-ISN Management Agent acquires from a central repository the configuration data needed by a single node of the DKN-ISN. When dispatched each management agent carries the configuration data to the appropriate node and updates the node's configuration. When the reconfiguration is complete, the agent sends a “Configuration successful” message and terminates.

An execution type of DKN-ISN Management Agent for each node involved in the DKN-ISN is configured from a central repository and dispatched to the node. When the DKN-ISN is to be started on the node, a decision that could be based on time or on arrival of a “go” message, the agent starts execution of the DKN-ISN on the node. The execution agent monitors startup and execution, reporting status as appropriate.

In many cases the only status messages will be “initialization complete” and “DKN-ISN node terminated normally.” Of course, the execution agent will also report anomalies detected during execution of the DKN-ISN. Detectable anomalies include errors written to log files, alert messages broadcast to listening clients, a missing event, or other complex events. When directed to do so, the execution agent shuts down the DKN-ISN node and starts the process of reporting results.

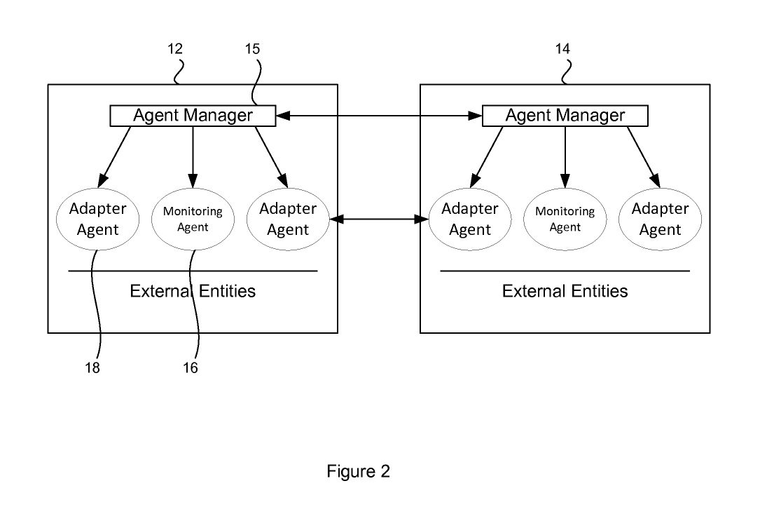

Using Adapter Agents and Agent Managers, intelligent, mobile agent platforms provide the infrastructure for mobility in a distributed system including remote communications, security and code mobility (Mobile Agents). FIG. 2 shows Agent-Based Linking of Distributed Systems Architecture. The key architectural components include agent managers 15 which reside on the nodes, e.g. Node A 12 and Node B 14. The agent managers control monitoring agents 16 and adapter agents 18. Functions of these agents will be described in more detail below.

Adapter Agent Capabilities

Adapter agents provides a connection between a local client and the larger system. Each Adapter implements the Adapter Agent interface. The Adapter Agent communicates with the local client and provides a consistent interface to the other system components. The local client may be as diverse as a DKN-ISN, an external sensor, smart-phone, tablet or desktop to name a few examples, though a greater range of potential devices and clients will be apparent to a person skilled in the art.

The Adapter Agent maintains a local table with available services provided by the client and known services that the client uses.

The Adapter Agent acts as an Agent Manager client. It relies upon the Manager for suggesting candidate services for fulfilling a client request for service.

The Adapter Agent can evaluate available services and chooses which to use by evaluating service descriptions.

Each existing system has an Adapter that publishes its interface to the Manager, which offers functionality and data to distributed consumers. The Adapter Agent knows how to access, filter and analyze its local DKN-ISN data.

A Mobile Agent is dispatched by an Adapter or Agent Manager to a remote platform. There, it may interact with the system hosted there, which might involve receiving large data volumes from the system, and after filtering and analyzing the data, sends the results back to the client from which the mobile agent had been dispatched. This streamlined process results in reduced network traffic and vulnerability to network outages.

Added value is achieved though peer-to-peer interaction among Adapters via Agents, thereby making the architecture more self-healing and independent of a centralized routing system.

The Agent Adapters implement the following interface AdapterAgentIntf and the interfaces below:

Data Store Interface
Boolean verifyDataSourceAccessibility( )—verifies node can be Queried
Boolean closeDataSourceResources( )—closes data source

Query Interface
Hashtable doQuery( )—Query node for data

Filter Interface
Hashtable doFilter(Hashtable aFilterExpression)—Filters data returned by Query

Analyze Interface
Hashtable doAnalysis(Hashtable aFilterExpression)—Executes rules returned by Filter

Persistence Interface
Boolean doStore(Hashtable aHashtableToBePersisted)—Stores data on specified

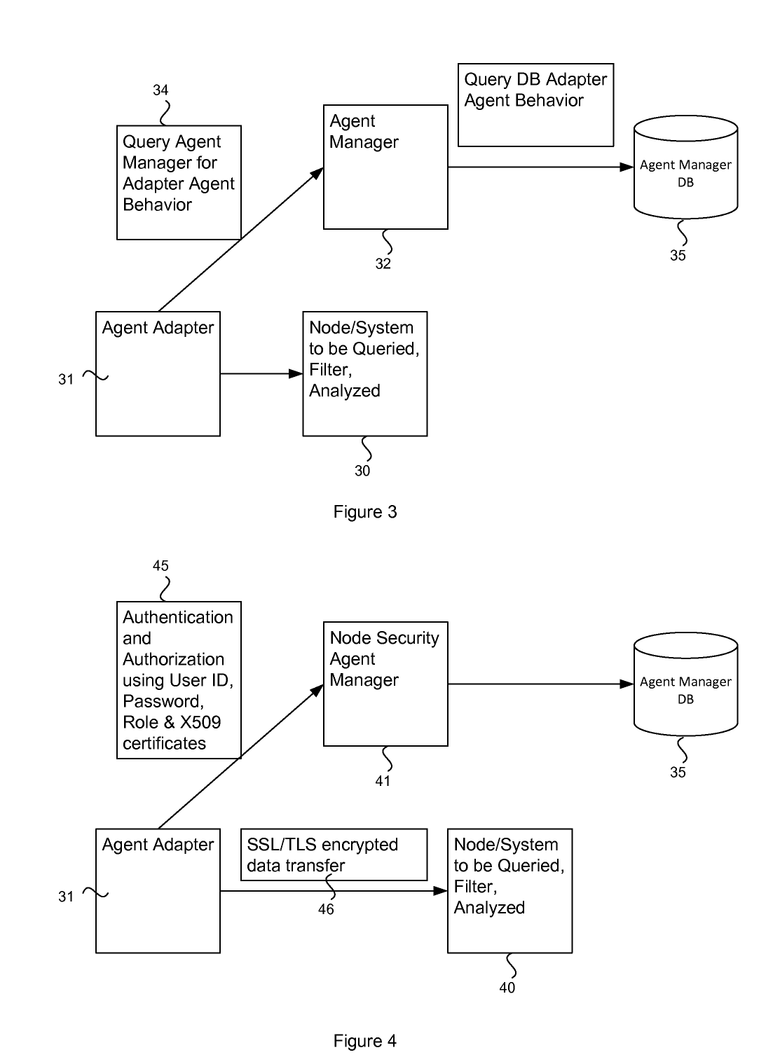

The Adapter Agent obtains references to these interfaces, by accessing them from the Agent Manager. For example, as shown in FIG. 3, an adapter agent 31 that has been deployed to a node 30 can reference the local agent manager 32 by sending a query for the adapter agent behavior. The Agent Manager 32 queries an Agent Manager Database 35 for the adapter agent behavior.

Adapter Agent Managers

The Agent Manager brokers links between Adapter Agents. Managers are themselves implemented as scalable agents. Adapters publish their services with the Manager, which maintains a local service database. Adapters make queries for services that match their needs. Once a service has been identified, the Adapter communicates with it directly, without going through the Manager.

Mobile Agents are created and dispatched to remote platforms by Managers to interact with another Adapter Agent or External Actors. Behavior of Mobile Agents is described in Java, C# or RETE-based rules and will also draw from intelligent systems technology, using an engine and a knowledge base. Additionally, enabled code mobility allows for dynamic loading of the latest versions of the mobile agent software. This results in an agent software infrastructure that keeps itself current, regardless of how widely distributed it is, with no additional work from DKN-ISN event controllers or administrators.

The Agent Managers implement the following interface AdapterManagerIntf and the interfaces below:

MobileAgentIntelligence
getMobileAgentIntelligence(String aAgentName)
MobileAgentIntelligence contains node specific implementations of the interfaces mentioned above:

Data Store Interface

Query Interface

Filter Interface

Analyze Interface

Persistence Interface

Only the Agent Manager knows how an Agent is going to query, filter and analyze data on a node it is managing. The Agent simply accesses the interfaces from the repository managed by the Adapter Agent Manager, and it executes the methods.

External Actors

External actors are discrete events or data published to a DKN-ISN system such as external sensors or systems. Each external actor optionally implements the standards interface to the Adapter Agent. An external actor requests services through their Adapter, or vice-versa, using the standard interface and receives replies with data. Specific Adapter Agents MAY have knowledge for communication with external Enterprise systems (JEE, .NET, ESB's, Web Services, CORBA, etc) or Simulation Systems such as Test and Training Enabling Architecture (TENA), which uses IIOP via a real-time CORBA implementation, High Level Architecture (HLA) Run Time Infrastructure (RTI), and Distributed Interactive DKN-ISN (DIS) Protocol Data Unit (PDU) which use UDP and TCP/IP.

Monitoring Agents and Applications

One or more management consoles actively manage the agents running the DKN-ISN with each console supervising a subset of the DKN-ISN nodes. These administrative console user interfaces may be accessible in a number of different form factors such as tablets, smartphones and PDA's, as well as on conventional workstations. This enables the DKN-ISN observers and controllers to access DKN-ISN results and the performance and status of the DKN-ISN exercise and systems regardless of their location and what device they use.

The Universal UI Capability is implemented thru the Pervasive Software Platform Universal User Interface Sub-Module, which is described in the Applicant's co-pending patent applications Attorney Docket Nos. 20091113.1 and 20080529.2, referenced above.

In addition to functioning on multiple devices and corresponding form-factors, Administrative Consoles should also have the flexibility to provide versions geared for Administrators of various levels of authority. Some administrators may have access to initiate, stop and restart systems constituting a DKN-ISN, while others are strictly observers of the DKN-ISNs, their changing states and performance levels. As shown in FIG. 4, Security Agent Managers 41 perform this authentication, both on the node/device that the management application is running and also on DKN-ISN nodes 40 being monitored, where they will be used to verify any administrative requests from the management nodes/devices (see figure below).

A DKN-ISN controller/administrator operating an administrator console creates DKN-ISN monitoring Task Agents, moves them to the assigned node, runs a DKN-ISN process, and returns them to the console with the results. While at the assigned node, the monitoring task agent tracks the progress of the DKN-ISN, reporting significant events back to the consoles.

DKN-ISN monitoring Task Agents can also be used for load-balancing purposes to transfer computationally intensive work to underutilized platforms within the system confined. They direct a DKN-ISN agent to move its processing to a node with greater available processing power. This of course must be weighed with any additional network traffic or DKN-ISN delays, which might result.

DKN-ISN Monitoring Agents & Agent Manager

DKN-ISN Monitoring Task Agents are responsible for managing a DKN-ISN. Under some circumstances, this can be a critical requirement for next-generation, self-healing and self-managing agent based systems. More specifically, these agents have the characteristics outlined below.

Monitoring agents collect different sets of DKN-ISN results, performance and resource usage information while minimizing network usage, resources usage and maximizing security. The processing power of available to all nodes involved in the DKN-ISN is also maximized, to any device, whether enterprise or handheld/embedded CPU's, or storage devices. Monitoring agents are dispatched from the Administrative tool(s) and/or dynamically loaded and executed on targeted DKN-ISN nodes. These Agents are responsible for launching the DKN-ISN process at the node where they reside, monitoring the DKN-ISN, and returning DKN-ISN and performance results back to one or more nodes running Administrative Tools.

All client-to-agent and agent-to-agent communication can be encrypted using a pluggable protocol framework that allows for SSL or TLS implementations utilizing key cryptography. DKN-ISN agents will travel with keys, but only agent managers will contain private keys, which will be accessible to a DKN-ISN agent arriving or resident at a node, only upon verifying the agent with security agent manager.

Authentication 45 may be accomplished using X.509 client and site certificates. Site certificates may be resident at each DKN-ISN node, and again are overseen by security agent managers 41. DKN-ISN agents will travel with client certificates containing its role information, as well as the identity and roles of the Administrator deploying it.

Authorization of Agents and Administrators is based on their roles, using a Role-Based Access Control Architecture (RBAC). A Super User is responsible for assigning roles to Administrators. An Agent Administrator using the Agent Monitoring tool assigns agent roles. The creation of private keys and X.509 Certificates, as well as their association with Agents and DKN-ISN nodes, is also managed by the Agent Administrator using the same tool. Administrator tool-based security is performed by a security Agent Manager resident on the management application nodes. The role of the administrator will be used to determine what capabilities he or she perform, such as creation of keys, certificates, association of such with Agents and nodes, and deployment, management and monitoring of Agents and the DKN-ISN processes for which they are responsible. Additionally, agent managers resident on the nodes actually running the DKN-ISN will verify and validate the arrival of DKN-ISN agents using the same RBAC architecture. The client certificate, containing identity, key and role information will be used by the Security Agent Manager to determine if the Agent may arrive at its node and start the DKN-ISN process and monitoring desired.

Node Monitoring Task Agents

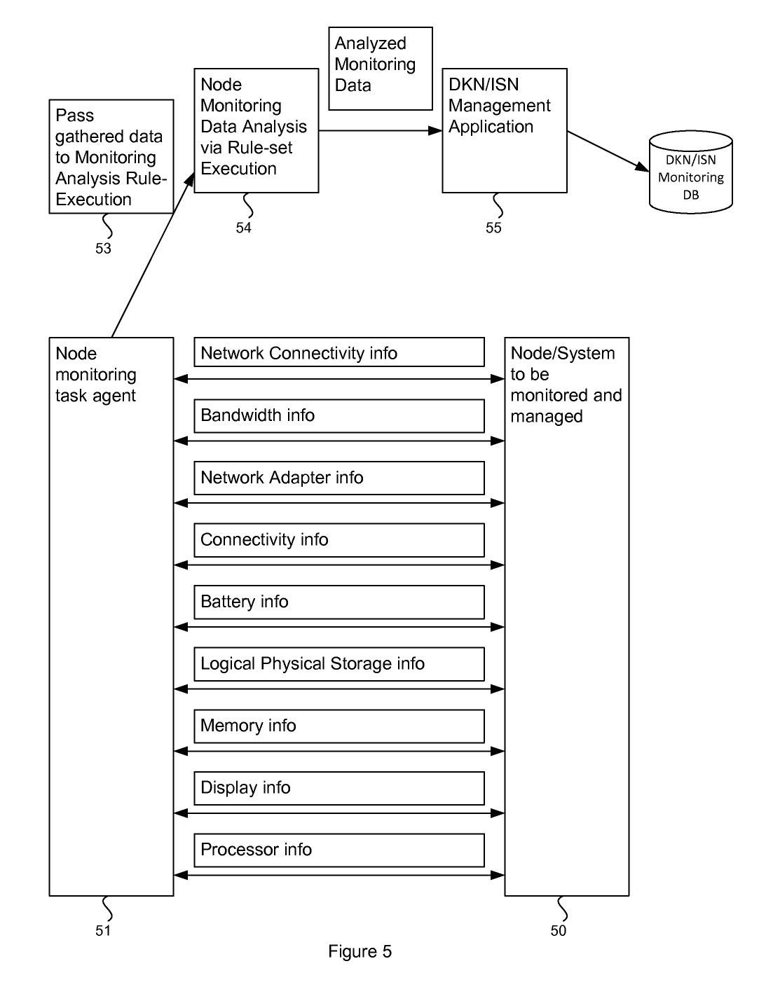

Node Monitoring Task Agents 51, as depicted in FIG. 5, are responsible for determining the current status of a node. This is a critical requirement for next-generation self-healing and self-managing agent based systems. More specifically, these agents need the characteristics outlined below. Agents can run in both Java (JSE, JME, Dalvik) and .NET (CLR, Compact Framework, Micro Framework) virtual machines. When a Virtual Machine is not present, the C/C++ versions of the Agents can be utilized. In this way, the monitoring agent does not require an additional virtual machine to be loaded on the DKN-ISN node. If that DKN-ISN node is running a .NET DKN-ISN application or process, the agent runs on the same .NET runtime. Similarly for Java, if that DKN-ISN node is running a Java DKN-ISN application or process, the agent run on the same Java runtime.

Agents, and the platform they run on, are lightweight and not resource intensive. These agents run in a process that is separate from the DKN-ISN process they are monitoring. In this way these monitoring agents do not impact the DKN-ISN in any way. If a monitoring agent encounters problems, it will not impact the corresponding DKN-ISN that it is monitoring.

Agents are autonomous, mobile and to a degree, self-healing. More specifically these agents are able to operate (i.e. monitor) without a network connection and report the information back to a Administrative Tools and Monitoring Agent Managers 55 once it detects the network connection has been re-established. Agent mobility and self-healing capabilities are in part related. If these monitoring agents are mobile, they have the ability to move to a nearby node, if it is determined that the DKN-ISN node is running low on resources.

Monitoring agents are manageable via standards such as Java Management Extensions (JMX). This enables agent access by multiple standards-based administrative tools in addition to the ones provided by the intelligent mobile agent platform.

Monitoring task agents 51 may be able to measure and react to the changing properties of the following aspects of a node 50, be it an embedded device or enterprise server, or anything in between. Node Monitoring Task Agents may have the ability to obtain the status of the hardware and network connections available. Specifically this includes:
Connectivity—System connectivity information, such as whether the system has at least one valid network interface connected to a network or whether a remote node is reachable.
Bandwidth—Monitors and control the network bandwidth or transfer rate.
Network Adapter—Used to describe the network adapters currently available in the system, such as Ethernet Wireless LAN, CDMA, GSM, EVDO, etc.
Connectivity Protocol—Used to describe the connectivity protocols running on the system, such as IEEE 802.11a, and to monitor the state of network connections.
Battery—Used to access information about a battery in the system, such as percent charge and life remaining.
Processor—Used to access information about the system microprocessor, such as the manufacturer, the current processor frequency, and whether streaming extensions are supported.
Platform—Used to access information about the system platform, such as when the system enters suspend mode or hibernate mode or shutdown.
Power—Information about system power, such as the system power source (battery or external AC) or the aggregated system battery charge.

This is accomplished by communicating directly with the native platform using Java→C/C++ (JNI), or Managed C#→Unmanaged C/C++ or C++→C/C++ communication. The data is assimilated to determine such valuable knowledge to a Monitoring Task Agent as its node's current state. From this it can determine if it needs to perform any self-healing, correction or move tasks and or files/databases etc to a healthier node.

The Node Capability Interface is the base interface of all Task Agents and comprises an Interface, which represents the type of information that can be gathered about status of the Node:
String printInfo( )
Hashtable getProperties( )

The Network Connectivity Interface supports properties which represent the type of information that can be gathered about status of Network Connectivity Attributes include:
Connectivity
Keys
Latency

The Bandwidth Interface supports properties which represent the type of information that can be gathered about status of Network Bandwidth:
Actual Rate
Theoretical Limit
Adaptable

The Network Adapter Interface supports properties which represent the type of information that can be gathered about status of Network Adapter:
Name
Type
Key
Enabled
Description
Connection Identifier
Device Identifiers
Manufacturer
Throughput
Current State
Supported Protocols

The Connectivity Protocol Interface supports properties which represent the type of information that can be gathered about status of the Connectivity Protocol:
Type
Key
Enable
IP Addresses
Mac Address
Multicast Addresses
Throughput
Current State
Identifiers
Network Type (WiFi, Telco, Bluetooth)

The WiFi Connectivity Protocol Interface supports properties which represent the type of information that can be gathered about status of the WiFi Connectivity Protocol:
Identifiers
Multicast Info
RTS Info
Antenna Info
Beacon Info
Frequency Info
Hop Info
Fragmentation Info
Duplication Info
Error Info
Retry Info

The Wireless Carrier Network Connectivity Protocol Interface supports properties which represent the type of information that can be gathered about status of the Wireless Carrier Network Connectivity Protocol:
Type
Key
Encryption Info
SIM Info
Network Info
Activated
Phone Number
ESN
IMSI
Signal Strength
CDMA Info
GPRS Info
LTE Info

The Bluetooth Connectivity Protocol Interface comprises an Interface, which represents the type of information that can be gathered about status of the Bluetooth Connectivity
Protocol:
Name
Addresses
Authentication and Encryption Info
Is Connectable
Connection Info
Discovery Info
Device Type
Manufacturer
Service Info

The Battery Interface comprises an Interface, which supports properties which represent the type of information that can be gathered about status of Battery:
Name
Id
Condition
Current Capacity
Estimated Time Remaining
Manufacturer Date
Manufacturer
Full Capacity
is Rechargeable
Alert Capacities
Time Remaining
Temperature
Voltage

The Logical Storage Interface supports properties which represent the type of information that can be gathered about information regarding each Logical Storage:
Identifier
Label
Accessibility
Format
Location
Capacity
Free Space

The Physical Storage Interface supports properties which represent the type of information that can be gathered about information regarding each Physical Storage:
Identifiers
Manufacturer
Size
Interfaces

The Memory Interface comprises an Interface, which represents the type of information that can be gathered about information regarding Memory:
Total Capacity
Available Space

The Processor Interface supports properties which represent the type of information that can be gathered about information regarding Processor Info:
Identifier
Manufacturer
CPU Usage Info
Model
Temperature
Capabilities
Frequencies
Voltages
Multiplier Info

The Display Interface supports properties which represent the type of information that can be gathered about information regarding the Display:
Resolution
Color Depth
Orientation
Pixel Density
State
Manufacturer
Product Name

Task Agents use this information to determine whether to move itself, or DKN-ISN agents resident on the same node, to nearby nodes to prevent system degradation or failure. This decision is determined based on rule-sets. For example, data determined and gathered by a node monitoring task agent 51 about a node 50 may be passed 53 to a module 54 configured to analyze the data via Rule-set execution. These agents may use any of several command languages, such as those written in Java or .NET languages or even C++ to describe their intelligence. They may also leverage or RETE-based expert system languages to incorporate reasoning to understand the state of the DKN-ISN node.

Monitoring Task Agents report results from local log files and databases located on the node, as well as the output of the reasoning engine, onto the Management console 55, or possibly to nearby monitoring agents so that they may act accordingly and preventively. All of these capabilities are available to DKN-ISN Adapter and monitoring Task Agents with the basic multi-language, multi-virtual machine, multi-operating system and multi-protocol capabilities outlined earlier.

Infrastructure Minimum Requirements and Protocol Interoperability

The minimum infrastructure needed for a next-generation, agent-based DKN-ISN architecture is intermittent network connectivity and computing platforms that run the Java Virtual Machine (JVM), the Microsoft .NET Common Language Runtime (CLR) or C/C++/Objective-C based platforms. Smartphones and PDA's will have a Linux, Android, IOS, JME, Compact Framework, .NET Micro Framework, and TinyOS compliant version of the intelligent, mobile agent platform installed for hosting and/or accessing Mobile Agents, dependent on the device specifications. The next-generation intelligent mobile agent platform may use combinations of Binary XML, REST-full APIs, Web Services (SOAP), CORBA (IIOP), Java (RMI) and XML-RPC industry standards to implement the remote communications and mobile agent capability. This will allow for agent communication with diverse systems due to the ubiquity of Java, .NET and the ever-increasing support of their corresponding virtual machines.

A next-generation intelligent, mobile agent platform will allow clients to develop real-time distributed knowledge networks, for commercial, civilian, and military distributed computing systems. This will help them to:
reduce the amount of raw data sent across wireless networks by enabling intelligent, onboard analysis utilizing mobile agents on edge devices to perform more of the data gathering, filtering and analysis required by distributed computing platforms;
reduce operating and administrative costs and make more efficient use of DKN-ISN environments (and the derivative real-world solutions), the wired and wireless networks over they pass information, and the enterprise server, desktops, embedded devices, tablets, PDA's and smart phones on which they query, filter, analyze DKN-ISN data and to which they send actionable knowledge;
provide a highly secure, easily managed and self-healing DKN-ISN capability that enables real-time feedback, and gather suggestions for improvements to DKN-ISNs, and distributed this information to a widely distributed audience regardless of the device to which they have access, and the network to which it is attached.

The components of the DKN-ISN may be embodied in hardware, software, firmware or a combination of hardware, software and/or firmware. For example, the node monitoring task agent may be embodied as computer executable instructions that are executable by a processor of a node of the DKN-ISN.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for monitoring a node of a distributed knowledge network/intelligent sensor network comprising:
deploying a node monitoring task agent to a node of the distributed knowledge network/intelligent sensor network;
executing the node monitoring task agent at the node;
determining one or more parameters of the node using the node monitoring task agent;
determining one or more self-healing tasks dependent on the one or more parameters; and
performing the one or more self-healing tasks.

2. The method of claim 1 wherein the one or more self-healing tasks comprises moving one or more agents of the distributed knowledge network/intelligent sensor network to another node of the network.

3. The method of claim 1 wherein determining one or more self-healing tasks comprises referencing a rule-set with the one or more determined parameters of the node.

4. The method of claim 1 wherein the one or more parameters of the node comprise one or more parameters of a task agent of the distributed knowledge network/intelligent sensor network that is executing on the node.

5. The method of claim 1 wherein the one or more parameters of the node comprise one or more of network connectivity of the node, bandwidth of the node, network adapter of the node, connectivity of the node, battery of the node, logical physical storage of the node, memory of the node, display of the node, and processor of the node.

6. The method of claim 1 wherein the node monitoring task agent executes independently of any processes of the distributed knowledge network/intelligent sensor network that the node monitoring task agent is monitoring.

7. The method of claim 1 comprising reporting the one or more parameters to a monitoring agent manager.

8. The method of claim 7 wherein the at least one node monitoring task agent is configured to monitor the node without a network connection and report the information to the Monitoring Agent Manager once the node monitoring task agent detects the network connection has been re-established.

9. A distributed knowledge network/intelligent sensor network comprising a plurality of nodes, at least one node comprising:
a node monitoring task agent configured to:
determine one or more parameters of the node; and
pass the one or more parameters to a node monitoring data analysis engine;
the distributed knowledge network/intelligent sensor network comprising the node monitoring data analysis engine configured to:
analyze the one or more parameters of the node by referencing a rule-set; and
pass the analyzed data to a management application;
wherein the management application is configured to determine one or more management actions for the node from the analyzed data.

10. The distributed knowledge network/intelligent sensor network of claim 9 wherein the management application is configured to instruct an agent executing on the at least one node to move the agent to another of the plurality nodes of the distributed knowledge network/intelligent sensor network.

11. The distributed knowledge network/intelligent sensor network of claim 9 wherein the node monitoring task agent is configured to determine one or more of network connectivity of the node, bandwidth of the node, network adapter of the node, connectivity of the node, battery of the node, logical physical storage of the node, memory of the node, display of the node, and processor of the node.

12. The distributed knowledge network/intelligent sensor network of claim 9 wherein the node monitoring task agent executes independently of any agent processes of the distributed knowledge network/intelligent sensor network that the node monitoring task agent is monitoring.

13. The distributed knowledge network/intelligent sensor network of claim 9 wherein the node monitoring task agent is configured to monitor the node without a network connection and report the information to the node monitoring data analysis engine once the node monitoring task agent detects the network connection has been re-established.

14. A computer-readable medium comprising computer-executable instructions for execution by at least one first processor, that, when executed, cause the at least one first processor to:
receive a node monitoring task agent into a node of a network;
execute the node monitoring task agent in the node;
determine one or more parameters of the node using the node monitoring task agent; and
pass the one or more parameters to a node monitoring data analysis engine.

15. The computer-readable medium of claim 14 comprising instructions, that, when executed by at least one second processor, cause the at least one second processor to:
receive the one or more parameters;
analyze the one or more parameters of the node by referencing a rule-set; and
pass the analyzed data to a management application.

16. The computer-readable medium of claim 15 comprising instructions, that, when executed cause the management application to determine one or more self-healing tasks dependent on the analyzed parameters.

17. The computer-readable medium of claim 16 comprising instructions, that, when executed cause the management application to move one or more agents of the distributed knowledge network/intelligent sensor network to another node of the network.

18. The computer-readable medium of claim 14 wherein the one or more parameters of the node comprise one or more of network connectivity of the node, bandwidth of the node, network adapter of the node, connectivity of the node, battery of the node, logical physical storage of the node, memory of the node, display of the node, and processor of the node

19. The computer-readable medium of claim 14 wherein the one or more parameters of the node comprise one or more parameters of a task agent of a distributed knowledge network/intelligent sensor network that is executing on the node.

20. The computer-readable medium of claim 19 wherein the node monitoring task agent executes independently of the task agent.
